(19) United States
(12) Patent Application Publication
(10) Pub. No.: US 2007/0095549 A1
(43) Pub. Date: May 3, 2007

(54) Side shift rake for sand trap vehicle

(75) Inventor: Andrew E. Modzik, Charlotte, NC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/265,223

(22) Filed: Nov. 1, 2005

(51) Int. Cl. A01B 49/02

(52) U.S. Cl. 172/173

(57) ABSTRACT

A side shift rake for a sand trap vehicle is connected to a prime mover having a pair of drive wheels. A beam supported from the prime mover is positionable substantially horizontal with respect to a ground surface and substantially perpendicular to a direction of travel of the prime mover. Multiple rake members are supported from the beam. A lateral translation device connected to a first one of the rake members translates all of the rake members in a direction substantially parallel to a beam longitudinal axis to both extend the rake assembly outboard of a wheel track and retract the rake assembly back to an initial position after a raking operation. The rake assembly is infinitely positionable between the initial and an extended position.

### TECHNICAL FIELD

The present teachings relate in general to sand conditioners, and more specifically to a device and method for operating a sand rake, functional at least for use on golf course sand traps.

### BACKGROUND

Multiple designs for sand trap rakes for golf courses are known. Both hand held rakes and rakes which are powered by a tractor or the like are known. These rakes use fingers for plowing through the sand for coarse sand preparation which are normally followed by a dresser having finer teeth or saw-tooth like edges to smooth the sand. Sand trap rakes are commonly used when the surface of the sand has been upset such as through daily use, or when the sand becomes hardened or wetted by weather conditions including dew, rain, snow, frost, and the like.

Common sand trap rakes which are pulled or otherwise controlled by a tractor commonly extend beyond a perimeter of the tires of the tractor. This permits the tire tracks that the tractor makes to be smoothed over as the tractor leaves the sand trap. Common powered sand trap rakes have several disadvantages. One disadvantage is that the varying configurations of sand traps found in most golf courses limits the surface area which the tires of the tractor can contact without damaging the sand trap itself. The limited extension of the rake assemblies beyond the footprint of the tires therefore limits the area which can be raked.

Rake designs which permit the individual rake assemblies to be extended beyond the envelope of the tires of the tractor such as disclosed in U.S. Pat. No. 5,263,306 to Tonutti provide horizontal support for the rake assemblies by extending a support wheel horizontally outward. The disadvantage of the Tonutti design if employed within a sand trap is the wheels which support the assembly upon horizontal extension do not permit the individual rakes to angularly deflect as the outer sloping wall of the sand trap is encountered. The wheel supports for the rake assembly of Tonutti also could cause additional damage to the outer sloping walls of a sand trap. Rake designs such as disclosed in U.S. Pat. No. 3,613,802 to Carlson et al. include multiple rake subassemblies which can rotate relative to each other to accommodate the changing geometry of a sand trap, however the Carlson et al. design does not permit the individual or assembled group of rakes to be horizontally extended with respect to the imprint of the tires of the tractor assembly. The conditioning device disclosed in U.S. Pat. No. 3,774,695 to Voorhees permits an outward folding extension of a sand rake assembly using a lever and a cable supporting an outer-most rake member. The device of Voorhees is extendable from only one side of the tractor assembly and does not provide for horizontal adjustment of individual rake assemblies.

Common sand trap rakes also have difficulty negotiating the curves and slopes of the many different types and depths of golf course sand traps. Common sand trap rakes are therefore narrow to negotiate the tight geometry and diverse contour of sand traps. The narrow design of common sand trap rakes and the geometry of the sand traps make it particularly difficult to maneuver around traps without simultaneously leaving tire tracks in the traps during sharp turns or upon departure from the trap of the tractor and rake. Portions of the sand trap(s) may also not be accessible due to limited adjustment of the rakes provided for common sand trap raking machines. Subsequent hand raking or finishing of traps can therefore be required to remove the tire marks and/or to rake the inaccessible areas, increasing the time and expense of maintaining the surface conditions of the traps.

### SUMMARY

According to some embodiments of the side shift rake for a sand trap vehicle, a beam is positionable substantially horizontal with respect to a ground surface and substantially perpendicular to a direction of beam travel. At least one rake assembly is supported from the beam. A lateral translation device is connected to the rake assembly to slidably translate the rake assembly in a direction substantially perpendicular to the direction of travel and coaxial to a longitudinal axis of the beam.

According to other embodiments, a sand trap rake system includes a prime mover having a pair of drive wheels. A beam supported from the prime mover is positionable substantially parallel with respect to a ground surface and substantially perpendicular to a direction of travel of the prime mover. A plurality of rake members are supported from the beam. A lateral translation device translates at least one of the rake members outboard of one of the drive wheels. The lateral translation device is connectable with the beam for motion in a direction substantially coaxial to a longitudinal axis of the beam.

According to still other embodiments, a method is provided for laterally shifting a sand trap rake mounted to a vehicle, the vehicle including a pair of driven wheels and a transfer device, the rake including a beam and at least one rake member. The method includes slidably connecting the rake member to the beam. The method further includes joining the transfer device to the rake member. The method still further includes slidably translating the rake member in a path parallel to a longitudinal axis of the beam using the transfer device to a position at least partially outboard of one of the driven wheels.

Further areas of applicability of the various embodiments will become apparent from the detailed description provided hereinafter. It should be understood that the detailed description and specific examples, while indicating various embodiments, are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a perspective view of a side shift rake assembly mounted to a rake vehicle according to various embodiments;

FIG. 2 is a front elevational view of the vehicle of FIG. 1;

FIG. 3 is a front elevational view similar to FIG. 2 showing an extended rake assembly;

FIG. 4 is a bottom plan view of the rake vehicle of FIG. 1;

FIG. 5 is a top plan view of the side shift rake assembly of FIG. 1;

FIG. 6 is a partial end elevational view of the side shift rake assembly of the present invention employed in an exemplary sand trap application; and

FIG. 7 is a top plan view similar to FIG. 5 showing another embodiment for a mechanism to translate the rake assembly.

### DETAILED DESCRIPTION

The following description of several various embodiments is merely exemplary in nature and is in no way intended to limit the teachings, their application, or uses. While the side shift rake for a sand trap vehicle described herein will be described generally as a sand trap rake connectable to a tractor, the teachings herein are equally applicable to all sand rakes however otherwise supported to a prime mover.

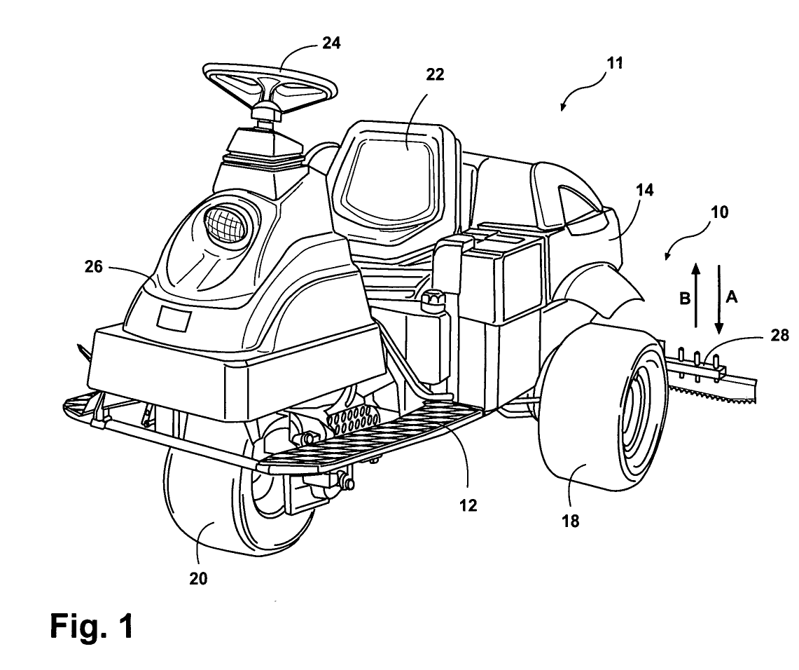

According to various embodiments and referring generally to FIG. 1, a side shift rake assembly 10 is mounted to rear structure of a rake vehicle 11. Side shift rake assembly 10 is displaceable to contact a trap surface in a rake engagement direction “A” and returned in a rake disengagement direction “B”. Vertical displacement of side shift rake assembly 10 is controlled by an operator of rake vehicle 11 using electrical or hydraulic controls/switches positioned within reach of the operator. Rake vehicle 11 includes a frame 12, a power unit section 14, a first drive wheel 16 (not shown in this view), a second drive wheel 18, and a front steerable wheel 20. A seat 22 is provided for the operator and is positioned proximate to a steering device 24 such as a steering wheel.

Rake vehicle 11 further includes a front housing 26 which encloses a steering mechanism connecting steering device 24 to steerable wheel 20. A rake assembly 28 is provided in various embodiments suspended from a rear section of rake vehicle 11. In other embodiments, rake assembly 28 can be disposed between first and second drive wheels 16, 18 and steerable wheel 20 or can alternately be positioned forward of steerable wheel 20. It should be evident that in various embodiments, one location for rake assembly 28 is aft of each of the first and second drive wheels and steerable wheel 20 to smooth a sand surface including any tire tread marks left by any of the wheels.

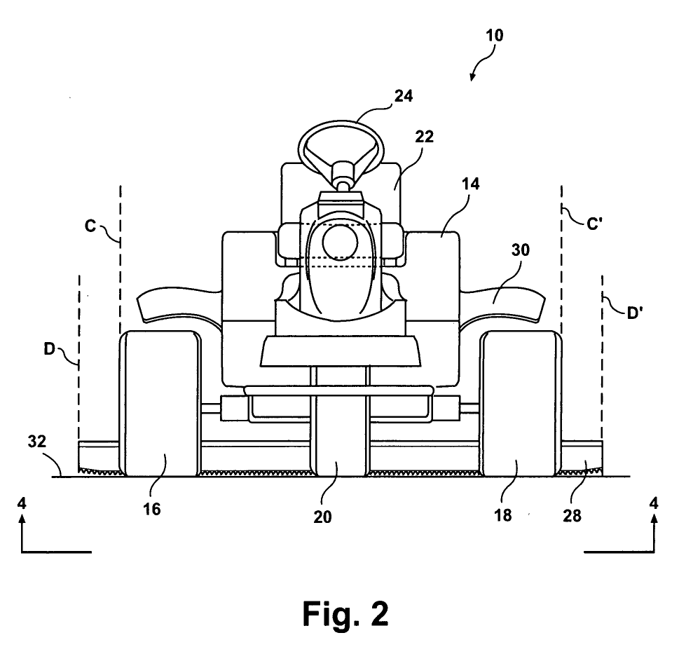

Referring now generally to FIG. 2, rake vehicle 11 can further include a pair of fenders 30 each disposed over one of first and second drive wheels 16, 18 used to deflect loose sand as the wheels spin and keep most of the deflected sand in front of rake assembly 28. As seen in FIG. 2, rake assembly 28 is disposed in a first position having portions of rake assembly 28 disposed outward of a wheel outer envelope C-C′. Rake assembly 28 defines a rake coverage envelope D-D′ extending beyond or outward of wheel outer envelope C-C′. Rake coverage envelope D-D′ ensures that tire tread marks are smoothed over as rake assembly 28 engages a trap surface 32. In the first position shown in FIG. 2, rake assembly 28 functions to smooth an entire path created by the wheels of rake vehicle 11.

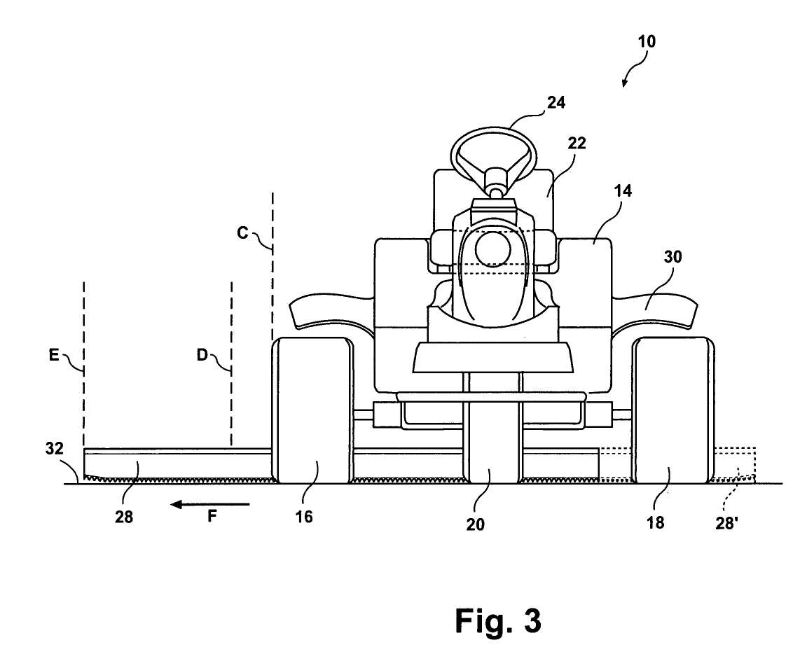

Referring now generally to FIG. 3, rake assembly 28 is horizontally displaced from the first position identified as rake assembly 28′ to a second, horizontally extended position defining a rake horizontal extension envelope E. To reach rake horizontal extension envelope E, rake assembly 28 is horizontally translated in a first rake movement direction F. By extending rake assembly 28 in first rake movement direction F, a portion of trap surface 32 which may not be normally accessible for rake vehicle 11 can be reached by rake assembly 28. Rake assembly 28 can then be retracted to its nominal first position shown in FIG. 2 for a final run to smooth out any tracks left by the various wheels 16, 18, 20. The rake assembly 28 is infinitely positionable between the first or initial position and the second horizontally extended, fully deployed position.

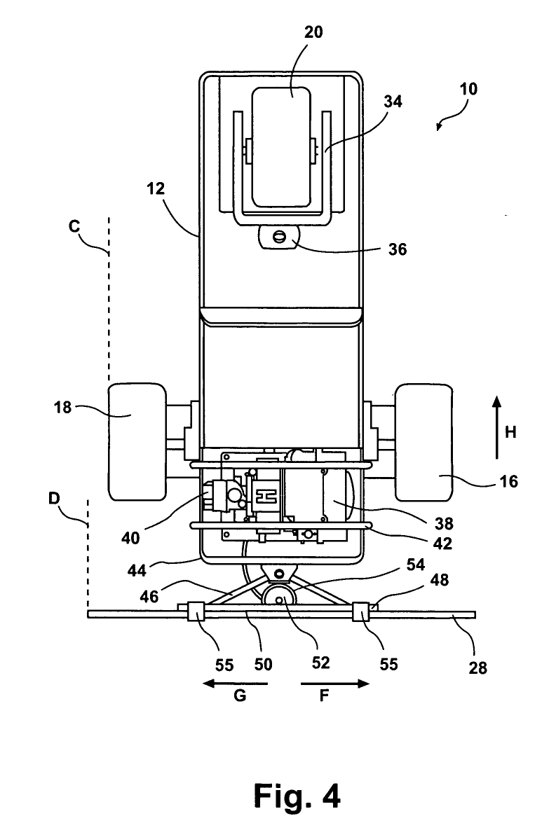

Referring now to FIG. 4, rake vehicle 11 further includes a yoke 34 rotatably connected to a steering mechanism 36 which is operable to rotate steerable wheel 20 when steering device 24 is actuated. Rake vehicle 11 further includes a power unit 38 which in this aspect is a combustion engine connected to a transmission 40. Power unit 38 can also be an electric power plant such as a group of batteries connected to an electric drive motor in place of a combustion engine for power unit 38. Power unit 38 may also be implemented as a hydraulic drive system. Power unit 38 and transmission 40 are supported by a power unit support structure 42 connected to frame 12. Rake assembly 28 is disposed from a rear frame member 44 using a rake structural frame 46.

In various embodiments, rake assembly 28 is horizontally displaced via a mechanical connection with a rake assembly support member 48. In these aspects, a gear rack 50 is disposed between rake assembly support member 48 and rake assembly 28. Gear rack 50 is engaged by a pinion gear 52 rotatably connected to a motor 54. Operation of motor 54 to rotate pinion gear 52 translates rake assembly 28 in either of the first rake movement direction F or a second rake movement direction G. In various embodiments, motor 54 is a DC motor electrically powered by a generator (not shown) powered by power unit 38. Rake assembly 28 can be slidably connected to rake assembly support member 48 using for example a pair of slide couplings 55 fastened or otherwise connected to rake assembly support member 48 and slidably engaging rake assembly 28. Rake vehicle 11 is normally propelled in a forward direction H during operation of rake assembly 28.

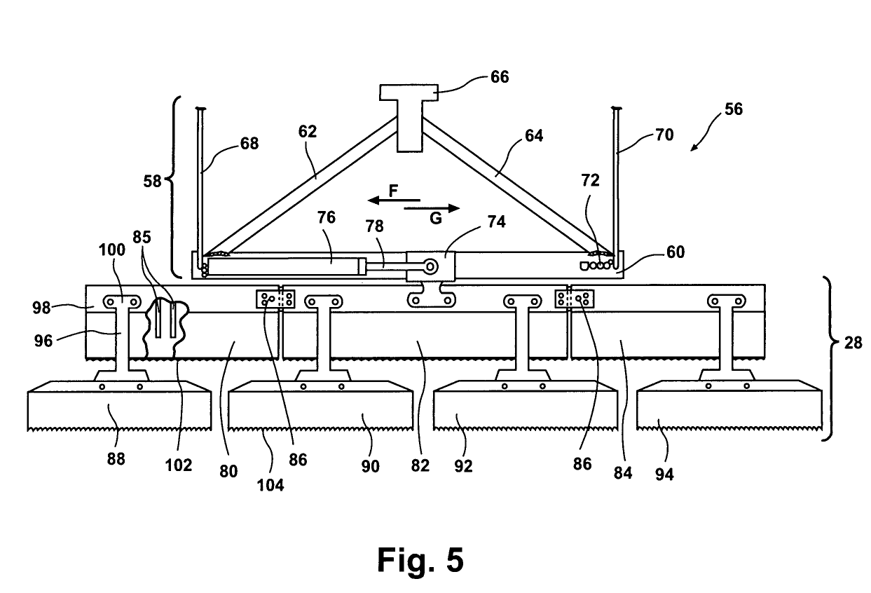

Referring now to FIG. 5, in various embodiments, rake assembly 28 is included in a rake unit 56. Rake unit 56 includes both rake assembly 28 and a support frame 58. Support frame 58 includes a support member or beam 60 such as a rectangular shaped tube having a first and second rigid connecting member 62, 64 joining (for example by welding or fastening) support beam 60 and a rotatably connectable hitch 66. Rotatably connectable hitch 66 is used to couple rake unit 56 to rake vehicle 11. To raise or lower rake assembly 28, a first and second lifting arm 68, 70 are rotatably connected to structure (not shown) of rake vehicle 11 and connected to support beam 60 using chains 72. Rake assembly 28 is normally, but not required to be raised above trap surface 32 using first and second lifting arms 68, 70 prior to horizontal displacement of rake assembly 28.

According to various embodiments, rake assembly 28 is slidably disposed to support beam 60 using a sliding coupling 74. Sliding coupling 74 is moved in either of first or second rake movement directions F or G using a piston 76 which translates a piston rod 78. Piston 76 is connected to support beam 60 and piston rod 78 is actuated using hydraulic fluid from a hydraulic system (not shown) provided with rake vehicle 11.

In some embodiments, rake assembly 28 includes each of a first, second and third rake housing 80, 82, 84. Each rake housing 80, 82, 84 includes a plurality of tines 85 which extend substantially downward to engage material in a sand trap. Tines 85 provide coarse mixing of the sand/soil. Each of the first, second and third rake housings 80, 82, 84 are rotatably connected to each other using at least one rotatable connector 86 such as a hinge. In the example shown, rotatable connectors 86 permit first and third rake housings 80, 84 to displace (i.e.: rotate) relative to second rake housing 82 to accommodate differences in topography of an individual sand trap.

Extending rearward from each of first, second and third rake housings 80, 82, 84 are each of a first, second, third and fourth dressing member, 88, 90, 92, 94. Each dressing member is connected to its respect rake housing using a connecting link 96 coupled to a support surface 98 of the rake housing using a flange 100 and fasteners. Each dressing member 88 through 94 can therefore be removed for repair or replacement from the individual rake housing. Each rake housing 80, 82, 84 further includes a plurality of dressing teeth 102 and each dressing member 88 through 94 includes a plurality of dressing teeth 104. Dressing teeth 102, 104 provide a finished appearance to the sand trap following coarse mixing by each of tines 85.

In other various embodiments (not shown), piston 76 and piston rod 78 can be replaced for example by an electric motor and gear assembly similar to motor 54 and pinion gear 52. Support beam 60 can also be replaced by a tube-within-a-tube assembly having an inner tube slidably disposed within an outer tube. Rake assembly 28 is connected to the inner tube and extendable laterally outward when the inner tube is translated. The inner tube can be extended for example using a hydraulic ram assembly similar to piston 76 and piston rod 78, or using pressurized air, an electric motor, or the like. The various embodiments are not limited to the type of drive unit used to translate rake assembly 28 horizontally inward or outward from rake vehicle 11. Other aspects of rake assembly 28 can be similar to the sand trap conditioner disclosed in U.S. Pat. No. 6,161,626 co-owned by the Assignee of the present teachings, the subject matter of which is incorporated herein by reference. Referring again to FIG. 3, a float device 33 can also be connected to rake assembly 28 to permit passive vertical displacement of rake assembly 28 to accommodate differing geometries of the ground surface.

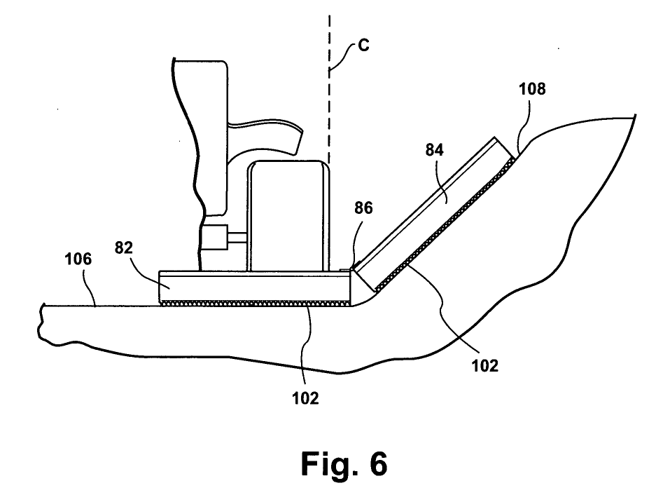

As best seen in reference to FIG. 6, when rake assembly 28 is horizontally extended to the rake horizontal extension envelope E, rotatable connectors 86 permit the outward positioned rake housing(s), in this example third rake housing 84, to rotatably displace with respect to second rake housing 82. The dressing members 92, 94 are not shown in this view for clarity. In this example, second rake housing 82 is positioned substantially horizontally with dressing teeth 102 in contact with a trap lower surface 106. Third rake housing 84 rotates to accommodate a trap outer sloping wall 108. By permitting the operator to control the relative horizontal displacement of rake assembly 28, side shift rake assembly 10 of the various embodiments permits the operator to selectively position the rake housings outward as necessary to accommodate the configuration of the particular sand trap while still providing dressing coverage behind most or all of the wheels of the rake vehicle 11. Rotatable connectors 86 permit automatic response to a changing topography of the sand trap without requiring additional operator action as the slope changes in the outer wall(s) of individual sand traps.

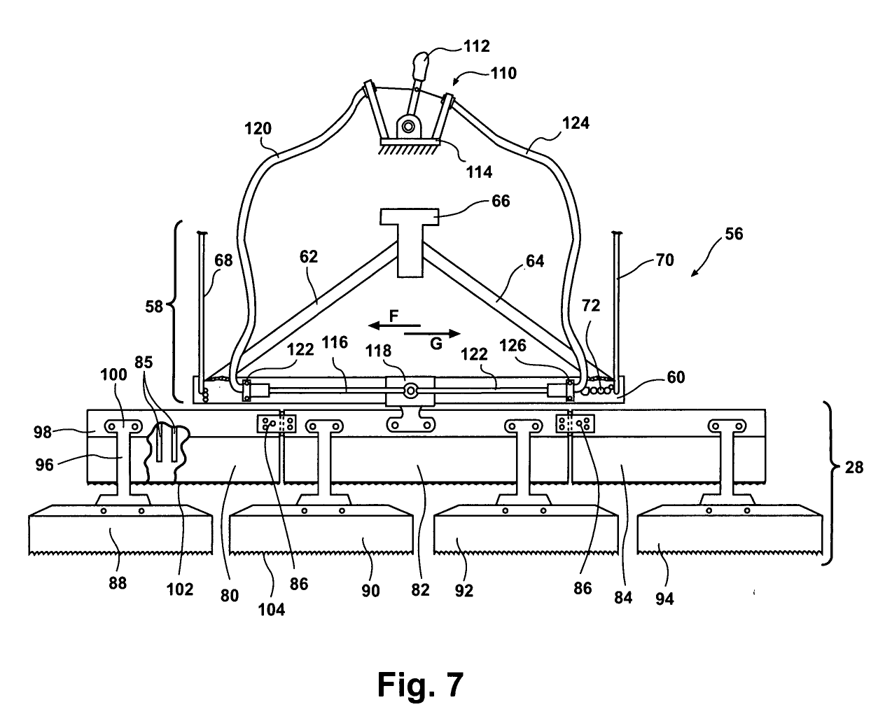

Referring generally to FIG. 7, in other embodiments a manually actuated lever assembly 110 is connected to structure of rake vehicle 11. Lever assembly 110 includes a lever 112 rotatably connected to a support structure 114. A push-pull wire 116 is connected between lever 112 and a sliding coupling 118 similar to sliding coupling 74. Push-pull wire 116 is slidably disposed within an outer flexible sheath 120. Flexible sheath 120 is anchored to beam 60 using a coupling element 122 at one end and is anchored to lever assembly 110 at a second end. Rotation of lever 112 causes displacement of push-pull wire 116 to displace sliding coupling 118 in either of the first or second rake movement directions F or G. A second push-pull wire 122 can also be used. Second push-pull wire 122 is oppositely connected to lever 112 from first push-pull wire 116 so that displacement of lever 112 in one direction acts to push one of push-pull wires 116, 122 and pull the other push-pull wire. Second wire 122 is slidably disposed in a second flexible sheath 124 which is anchored to beam 60 using a second coupling element 126 at one end, and is anchored to lever assembly 110 at an opposite end. A length of lever 112 and the attachment point of wire(s) 116 and/or 122 therefore determines a total displacement of sliding coupling 118 and therefore rake assembly 28.

Side shift rake assemblies of the various embodiments are not limited to the configurations shown herein. A greater or lesser quantity of rake housings 80, 82, 84 and/or dressing members 88 through 94 can be used without departing from the scope of the various embodiments. Multiple types of drive mechanisms can be used to horizontally translate the side shift rake assemblies of the various embodiments.

A side shift rake for a sand trap vehicle of the various embodiments offers several advantages. By horizontally extending a rake assembly, an operator can position one or more rake members to accommodate varying sand trap wall geometries and pitch angles. By providing discrete control of the amount of horizontal displacement of a rake assembly, an operator can adjust the position of rake members to accommodate a rake vehicle tight turning radius, local irregularities in trap geometry, and/or extend to trap areas which a normally fixed rake assembly cannot reach. Providing automatic rather than manual control reduces operator fatigue and permits continuous adjustment of the rake outward position. An operator can also extend the rake to individually reach specific areas of a trap which would otherwise require an additional pass by the tractor, or hand grading.

The description of the various embodiments is merely exemplary in nature and, thus, variations that do not depart from the gist of the teachings are intended to be within the scope of the teachings. Such variations are not to be regarded as a departure from the spirit and scope of the teachings.

What is claimed is:

1. A sand trap rake system, comprising:
a beam positionable substantially horizontal with respect to a ground surface and substantially perpendicular to a direction of beam travel;
at least one rake assembly supported from the beam; and
a lateral translation device connectable to the rake assembly and operable to slidably translate the rake assembly in a direction substantially perpendicular to the direction of travel and coaxial to a longitudinal axis of the beam.

2. The system of claim 1, wherein the lateral translation device further comprises:
a rack and pinion gear assembly operable to displace the beam; and
a drive unit operable to rotate a pinion gear of the rack and pinion gear assembly.

3. The system of claim 1, wherein the lateral translation device further comprises a hydraulic actuator.

4. The system of claim 1, wherein the lateral translation device further comprises an electric motor.

5. The system of claim 1, wherein the lateral translation device further comprises a lever assembly having at least one push-pull wire connectable to the rake assembly.

6. The system of claim 1, further comprising a second beam slidably extendable from the beam, the rake assembly being connectable to the second beam, wherein the lateral translation device is connectable to both the second beam and the rake assembly.

7. The system of claim 1, further comprising a coupling operable to slidably join the rake assembly to the beam wherein the rake assembly is slidably disposed with respect to the beam.

8. The system of claim 1, wherein the rake assembly further comprises a plurality of tines.

9. The system of claim 1, wherein the lateral translation device is further connectable to the beam and operable to simultaneously translate both the beam and the rake assembly.

10. The system of claim 1, wherein the rake assembly is infinitely positionable between an initial position and a fully deployed position.

11. A sand trap rake system, comprising:
a prime mover having a pair of drive wheels;
a beam supported from the prime mover and positionable substantially parallel with respect to a ground surface and substantially perpendicular to a direction of travel of the prime mover;
a plurality of rake members supported from the beam; and
a lateral translation device operable to translate at least one of the rake members outboard of one of the drive wheels, the lateral translation device connectable with the beam for motion in a direction substantially coaxial to a longitudinal axis of the beam.

12. The system of claim 11, wherein the lateral translation device is operable to translate a first one of the rake members between a first position and a second position, the second position having the first one of the rake members positioned entirely outboard of one of the drive wheels.

13. The system of claim 12, wherein the second position defines an infinitely adjustable location selectable by an operator of the prime mover.

14. The system of claim 11, further comprising a second beam slidably extendable from the first beam, at least a first one of the rake members being connectable to the second beam, wherein the lateral translation device is connectable to both the second beam and the first one of the rake members.

15. The system of claim 11, further comprising a coupling operable to slidably join a first one of the rake members to the beam wherein all of the rake members are simultaneously laterally translatable by translation of the coupling with respect to the direction of travel of the prime mover.

16. The system of claim 11, wherein the lateral translation device further comprises a hydraulic actuator.

17. The system of claim 11, wherein the lateral translation device further comprises an electric motor.

18. The system of claim 11, wherein the lateral translation device further comprises a manually operated lever assembly having at least one push-pull wire connectable to the rake assembly.

19. The system of claim 11, wherein the rake assembly further comprises a float device operable to permit passive vertical displacement of the rake members to accommodate differing geometries of the ground surface.

20. The system of claim 11, wherein individual ones of the plurality of rake members are rotatable with respect to each other to permit each of the plurality of rake members to individually follow a contour of the ground surface

21. A method for laterally shifting a sand trap rake mounted to a vehicle, the vehicle including a pair of driven wheels and a transfer device, the rake including a beam and at least one rake member, the method comprising:
slidably connecting the rake member to the beam;
joining the transfer device to the rake member; and
slidably translating the rake member in a path parallel to a longitudinal axis of the beam using the transfer device to a position at least partially outboard of one of the driven wheels.

22. The method of claim 21, further comprising lifting the beam prior to the translating operation.

23. The method of claim 21, further comprising slidably connecting the rake member to the beam.

24. The method of claim 21, further comprising performing the translating operation until the rake member is outside an envelope defined by the pair of driven wheels as a linear translation.

25. The method of claim 21, further comprising positioning the rake member in one of a plurality of outwardly directed sand engaging positions selectable by an operator of the vehicle.

26. The method of claim 21, further comprising rotatably supporting the rake member to the beam.

27. The method of claim 21, further comprising linearly moving the beam together with the rake member during the translating operation.

28. The method of claim 21, further comprising linearly retracting the rake member to an initial position after a raking operation.

29. The method of claim 21, selecting one of an infinite number of rake member positions between an initial rake member position and a fully extended rake member position.

30. The method of claim 21, further comprising continuously changing a position of the rake member during operation of the vehicle.
